(19) United States
(12) Patent Application Publication
(10) Pub. No.: US 2005/0200126 A1
(43) Pub. Date: Sep. 15, 2005

(54) Connecting device for fluid conduits

(75) Inventor: Daniel Fischer, Romanshorn (CH)

Correspondence Address: KODA & ANDROLIA, 2029 CENTURY PARK EAST, SUITE 1140, LOS ANGELES, CA, 90067, US

(73) Assignee: Eugster/Frismag AG

(21) Appl. No.: 11/003,710

(22) Filed: Dec. 3, 2004

(30) Foreign Application Priority Data
Dec. 5, 2003 (CH) 203 18 857.8 (U)

(51) Int. Cl. F16L 37/00

(52) U.S. Cl. 285/305

(57) ABSTRACT

A connecting device for fluid conduits having at least one connecting element that is suitable for tightly connecting two line ends to one another, wherein a coupling sleeve (4) having a front annular end face and a rear annular end face makes positive friction fit contact with an end section of a first line (1). A connecting sleeve (5, 14) projects from one end of a second line (2, 13), and inside the connecting sleeve an annular shoulder is formed that is suitable for receiving the end section of the first line (1) together with the coupling sleeve (4). A locking element is detachably mounted on the connecting sleeve (5, 14) which contacts the rear end face of the coupling sleeve (4) inserted into the connecting sleeve.

### BACKGROUND OF THE INVENTION

1. Field of the Invention

The invention relates to a connecting device for fluid conduits.

2. Prior Art

Generically, the connecting device for fluid conduits is designed with at least one connecting element that is suitable for tightly connecting two lines to one another.

A tight connection is understood to mean a pressure-tight connection which in particular prevents the discharge of liquid under pressure.

The connecting device for fluid conduits is provided in particular in coffee and espresso machines.

According to the prior art, hose and tube connections are produced by adhesive bonding, for example. However, such connections involve connection procedures that require precise timing, in particular for the curing of an adhesive. The finished connections are not easily detachable.

Other, detachable connections are achieved, for example, using coupling nuts and cooperating threaded connecting parts. These connection arrangements require parts that are expensive to manufacture, in addition to time-intensive installation procedures.

The prior art also includes a tube connection having a clamping sleeve comprising two sleeve half-shells which screw into one another and whose flange-like projections are tightened together by screws (DE-A-198 37 803). The clamping sleeve overlaps two tube ends, a first tube end having an annular bulge and a second profiled tube end having a section of larger diameter. In addition, due to the screwing and tightening the clamping sleeve is cumbersome to install, and is not very well suited for connecting two hose ends.

Other tube connectors of the prior art are used only for connecting a specialized tube end to at least one annularly expanded wall (DE 41 42 640, U.S. Pat. No. 6,086,118).

In one known connecting device for fluid conduits of the aforementioned generic type to which a hose end can be connected, a metal ring is used as a coupling sleeve, from which internal hook-shaped projections are formed which externally engage with the hose end as a first line (U.S. Pat. No. 3,637,240). In particular by eddy-current induction in, and accompanying heating of, the metal ring, the hook-shaped projections are anchored in the plastic line thus softened. However, nicks are created in the hose end, thus weakening it. On the other side, a connecting sleeve has an internal borehole in which the hose end can engage, in addition to an expanded internal borehole into which the metal ring on the end section of the first line fits. In a space in the connecting sleeve, between an annular shoulder formed between the internal borehole and the expanded internal borehole, and a front annular front face of the metal ring, a sealing O-ring made of rubber or an elastomer is inserted which contacts the front annular end face of the metal ring but which does not simultaneously contact the annular shoulder in the connecting sleeve. Thus, a seal can be produced on an internal peripheral side and on the external peripheral side of the metal ring only when the O-ring is tightly fitted to both the first line and the internal periphery of the connecting sleeve. For installation, an essentially U-shaped clamp is used which is inserted into lateral boreholes in the connecting sleeve, namely, behind the connecting sleeve that is inserted into the connecting sleeve together with the end section of the first line.

### BRIEF SUMMARY OF THE INVENTION

The object of the present invention, therefore, is to provide a connecting device for fluid conduits that functions using connecting elements that are easily manufactured, with connection procedures that are quickly performed, while at the same time providing a good external seal for the lines connected to one another. The connecting device for fluid conduits is distinguished by versatile applications, and, if necessary, line connections made with same are detachable.

This object is achieved by a connecting device for fluid conduits having the features stated in the characterizing part of claim 1.

The object is achieved by placing on an end section of a first line a coupling sleeve having an annular end face on the front side, i.e., external to the connection side, that has an annular shape next to a first line end, and having a rear, annular end face situated at a distance from the first line end, that makes positive friction fit contact. For this purpose, the inside of the coupling sleeve has a simple, continuous cylindrical peripheral wall that is placed, for example crimped, on a correspondingly continuous end section of the first line, which similarly has no bead-like expansion. In this respect, a line may be understood to be a flexible line or a hose, in particular made of plastic, or a rigid line or line section made of plastic, or a metal tube. A connecting sleeve that projects from one end of a second line to be connected to the first line is suitable for receiving the end section of the first line together with the coupling sleeve.

Inside the connecting sleeve, at the end of the second line or of the line section forming the second line, an annular shoulder is provided which together with the front annular end face of the coupling sleeve performs a sealing function. By detachably placing a locking element on the connecting sleeve, which locking element in the interlocked state of the coupling sleeve and the connecting sleeve contacts the rear end face of the coupling sleeve, in the inventive design of the fluid connection arrangement, in particular for the interior of the connecting sleeve and the length and position of the coupling sleeve on the end section of the first line, the front annular end face of the coupling sleeve directly or—via a sealing element, indirectly—comes to rest on the annular shoulder of the connecting sleeve. It is thus possible to achieve a fluid connection arrangement that provides a reliable seal, even at high internal pressures.

As a sealing element, in particular according to claim 2, a simple O-ring may be used which is enclosed with a tight fit between the annular shoulder of the connecting sleeve and the front annular end face of the coupling sleeve. By pressing the O-ring between the annular shoulder of the connecting sleeve and the front annular end face of the coupling sleeve, the O-ring may also create a good seal on its outer periphery in the connecting sleeve and on its inner periphery on the end section of the first line.

In this manner, it is possible to achieve a tight fit of the coupling sleeve on the end section of the first line.

The mutually contacting walls of the coupling sleeve in addition to the connecting sleeve are essentially cylindrical according to claim 3. These allow a reliable connection that is independent of the rotational position of the coupling sleeve and the connecting sleeve.

Further advantageous features of the connecting device for fluid conduits are stated in claims 4 through 16.

According to claim 4, the connecting sleeve is an injection-molded plastic part, which is favorable for manufacturing.

To further streamline manufacture, according to claim 5, the connecting sleeve together with the end of the second line may be formed from plastic, it also being possible for the second line to be an outlet or inlet for another integral structural element. In this case, the second line is preferably a rigid plastic line.

However, according to claim 6, it is also possible for the connecting sleeve to be made of metal, and to be soldered onto an end section of a metal tube as a second line.

The coupling sleeve which is mounted on the end section of the first line has a simple ring-shaped design, and is preferably made of metal. However, the ring may also be injection molded as a rigid plastic part.

An alternative embodiment of the connecting sleeve according to claim 8 has a first section that receives an end section of the first line in addition to a second section that is narrower than the first section and projects from one end of the first line. The front, annular end face is thus formed as a sealing surface by means of a shoulder between the first section and the second section. The inside diameter of the first section of the coupling sleeve corresponds to the outer diameter of the first line. The diameter of the second section is smaller than that of the first section. The second section projects beyond the end of the first line in the installed state, so that this end forms a guide for the coupling sleeve in the receiving connecting sleeve.

Furthermore, according to claim 9, a support tube may be inserted into the end section of the first line which is able to support the end section when the coupling sleeve is pushed on.

By use of the form features of the aforementioned connecting device for fluid conduits, at least two connecting sleeves according to claim 10 may be formed in a common connecting part which comprises at least one line section connecting the connecting sleeves. In particular, the common connecting part may be designed with three connecting sleeves which are connected to one another in the connecting part via a branched line section. The latter connecting part may thus be referred to as a three-sided connecting part. As mentioned above, one of the connecting sleeves may also be an integral component of another structural element, such as a continuous flow heater, for ex ample.

Furthermore, two embodiments of the locking element have been developed which are used to hold the coupling sleeve in its desired position when inserted into the connecting sleeve:

In a first embodiment according to claim 12, the locking element is designed as a spring clip that extends through an internally laterally open receiving slot in the connecting sleeve and comes to rest against the rear annular end face of the inserted coupling sleeve. If necessary, the spring clip may be removed from the receiving slot to detach the connection of the connecting sleeve to the coupling sleeve. Likewise, the spring clip is reusable.

In one variant, the receiving slot in the connecting sleeve is also laterally open to the outside. This allows for uncomplicated fabrication of the connecting sleeve and easier handling of the spring clip for locking or loosening the fluid line connection.

However, according to claim 14, it is also possible for the connecting sleeve to be laterally closed to the outside, so that the spring clip essentially goes all the way into the receiving slot and is held therein, even when forces are exerted on the spring clip from internal pressure in the hoses, which in the worst-case scenario tend to laterally push the spring clip from the receiving slot.

Alternatively, the locking element according to claim 15 may be designed as connected half-shells that fold together. On their face ends the half-shells have ridges with recesses, so that the coupling sleeve and the connecting sleeve which receives the coupling sleeve are enclosed between the folded-together, interlocked half-shells and the ridges. By releasing the interlocking elements, the half-shells may once again be removed from the line ends with the connecting sleeve and the coupling sleeve to loosen the connection of the two line ends. Likewise, the half-shells are reusable.

According to claim 16, both half-shells and the elements molded thereon are made of plastic.

It is particularly advantageous for the half-shells to be captively connected to one another as a single piece by means of a film hinge. This locking element may be economically manufactured and installed, since the relative position of the half-shells is fixed in place on the hinge side, and the half-shells need be connected only on the opposite side by interlocking elements in order to enclose the line ends.

All of the variants of the connecting device for fluid conduits according to the invention are suitable for quick assembly.

### BRIEF DESCRIPTION OF THE SEVERAL VIEWS OF THE DRAWINGS

FIG. 1 shows a first embodiment of the connecting device for fluid conduits as an exploded view;

FIG. 2 shows the connecting device for fluid conduits according to FIG. 1, but completely assembled as a sectional drawing;

FIG. 3 shows a second embodiment of the connecting device for fluid conduits as a variant of the first embodiment, as an exploded view;

FIG. 4 shows a third embodiment of the connecting device for fluid conduits as an exploded view;

FIG. 5 shows the completely assembled connecting device for fluid conduits according to FIG. 4, as a longitudinal section;

FIG. 6 shows a detail of the third embodiment, namely, a locking element having half-shells in the folded-up state in a front view; and

FIG. 7 shows a fourth embodiment of the connecting device for fluid conduits in the assembled state, in a sectional view.

Corresponding parts in the various embodiments are provided with the same reference numbers in all figures.

### DETAILED DESCRIPTION OF THE INVENTION

Exemplary embodiments of the connecting device for fluid conduits according to the invention are described below, with reference to the drawings comprising seven figures, as follows:

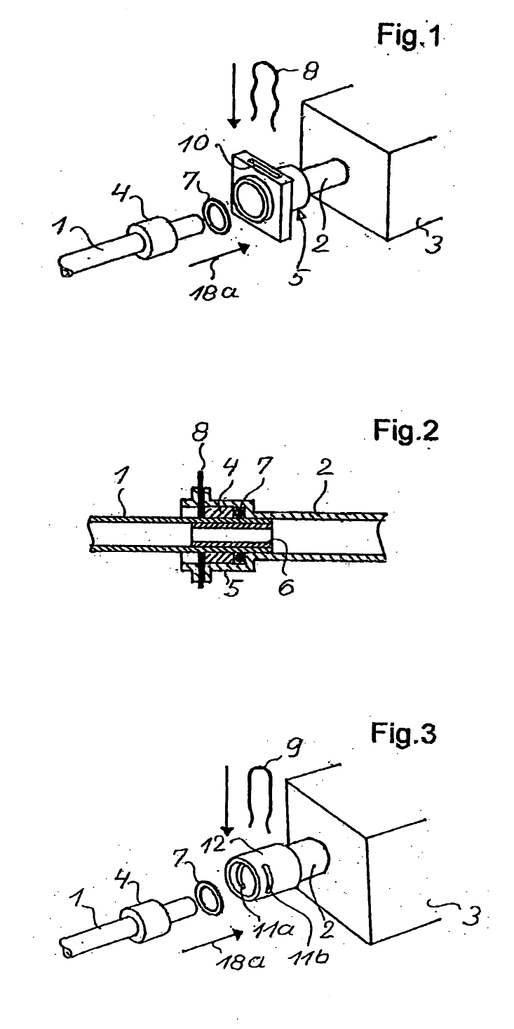

FIG. 1 shows in detail a flexible plastic line as a first line 1, together with a rigid plastic line as a second line 2 which is part of a structural element 3, a continuous flow heater, for example (only partially shown), for connecting to a connecting device for fluid conduits.

For this purpose, a coupling sleeve 4 designed as a metal ring, which is used to fix the first line 1 in place in a connecting sleeve 5, is crimped onto the flexible plastic line or first line 1, just in front of its connection-side end. To prevent the flexible plastic line as first line 1 from being deformed by the crimping process and to ensure a secure seating of the coupling sleeve 2, an inserted support tube 6 is located on the connection-side end of the flexible plastic line in the vicinity of the coupling sleeve 2.

The connection of lines 1 and 2 is achieved by the connecting sleeve 5, into which lines 1, 2 are inserted. To create a seal, on the side of the connecting sleeve 5 an O-ring 7 is provided which contacts a connection-side end face of the coupling sleeve 4 (not designated by a reference number) and a shoulder (likewise not designated by a reference number) at which the second line 2 ends and the connecting sleeve merges into a section of larger inner diameter which receives the coupling sleeve 4. The section of the first line 1 situated at the connection-side end of the coupling sleeve 4 is thereby pushed through the O-ring.

In the first embodiment according to FIGS. 1 and 2 and in the second embodiment according to FIG. 3, the connection of the two lines 1 and 2 is locked by a spring clip 8 or 9, respectively, which in each case is pushed through a pair of receiving slots oppositely situated in the connecting sleeve until the spring clip comes to rest against the end face of the coupling sleeve 4 facing away from the connection-side end. In the first embodiment according to FIGS. 1 and 2, the receiving slots are laterally closed off in an expanded section of the connecting sleeve 5; an opening 10 only on the top side, visible in FIG. 1, is located at right angles between the two actual receiving slots, not shown. On the other hand, in the embodiment according to FIG. 3, the receiving slots 11a and 11b are laterally open to the outside, thereby simplifying the shaping of the coupling sleeve 12. As a result, the spring clip 8 is situated inside the connecting sleeve 5, and the spring clip 9 is situated partially outside the connecting sleeve 12.

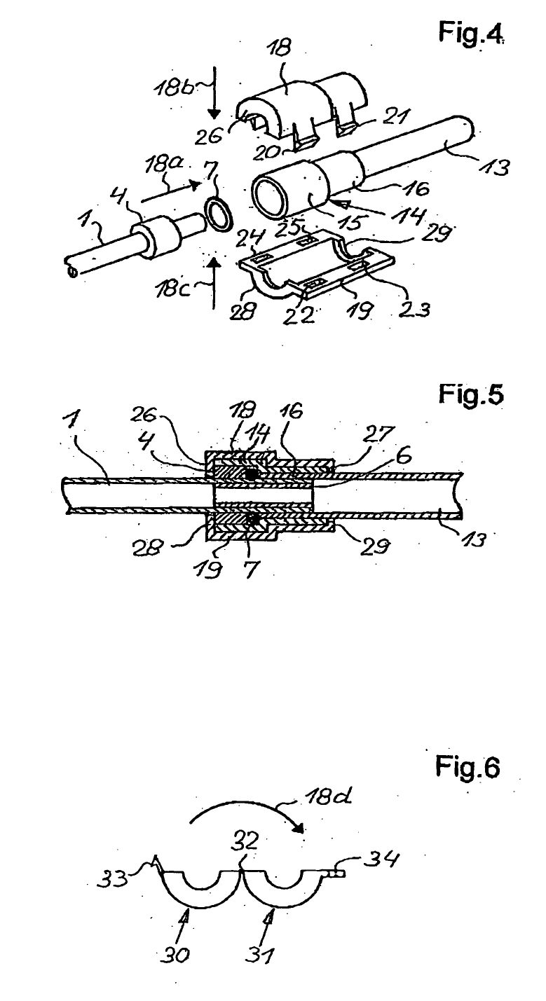

The third embodiment of the connecting device for fluid conduits according to FIGS. 4 and 5 is used to connect a first line 1, which once again is a flexible plastic line, to a second line 13, which in this instance is designed as a rigid metal line or tube. Accordingly, a coupling sleeve 4 and a support tube 6 are situated on an end section of the first line 1 in a manner similar to that described for FIGS. 1 and 2. A connecting sleeve 14 in this instance is made of metal, and once again has a first section 15 of relatively large diameter which is suitable for receiving an end section of the first line 1, in addition to a second section 16 of smaller diameter into which the second line 13 or tube is inserted in order to be soldered to the second section. As can be seen from FIG. 5, between the first section and the second section a shoulder is formed on which the O-ring 7 comes to rest when the front section of the line 1 with the O-ring is pushed into the connecting sleeve until the O-ring 7 presses tightly against the front end face of the coupling sleeve 4 and the shoulder between sections 15, 16. The direction in which the first line 1 is pushed is indicated by an arrow 18a in FIG. 4, for example.

The pushed-together lines 1 and 13 can then be locked by clipping together two half-shells 18, 19, made of plastic, in the direction of arrows 18b, 18c to produce a closed, approximately cylindrical shape over the coupling sleeve 4 and connecting sleeve 14. For this purpose, half-shell 18 has spring tabs 20, 21 as interlocking elements which fit into slots 22, 23. Additional spring tabs, not shown in FIG. 4, may be received by slots 24, 25. The slots thus have a locking function. As can be seen from FIG. 5, when the half-shells 18, 19 are in the clipped-on position their ridges 26-29 on the end-face side inwardly contact the rear, i.e., the side facing away from the connection site, end faces of the coupling sleeve 4 and connecting sleeve 14.

It should be noted that the second line 13 once again may be a component of a structural element, not illustrated.

In FIG. 6, half-shells 30, 31, shown from the front, are provided as injection-molded parts together with a film hinge 32, and for mutual locking in the folded-down state (see arrow 18d) therefore have fewer spring tabs, e.g. 33, and slots, e.g. 34, which can engage with one another to securely enclose a connecting sleeve and a coupling sleeve.

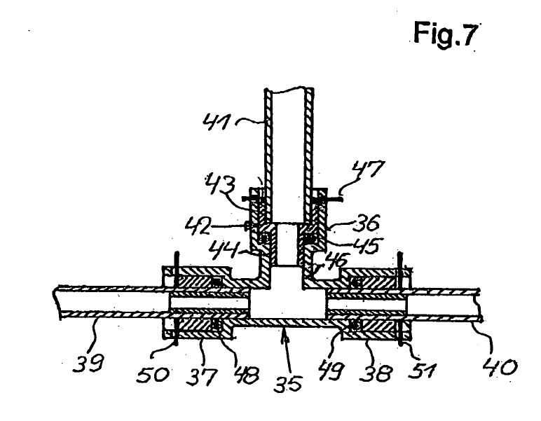

One particularly interesting embodiment of the connecting device for fluid conduits is illustrated in FIG. 7 in which the connecting device for fluid conduits comprises a connecting part 35 from which three connecting sleeves 36, 37, 38 are formed. The common connecting part is thus suitable for receiving three lines which can communicate with one another in the essentially T-shaped connecting part. In a manner similar in principle, variants of the common connecting part can be provided for receiving only two lines, which can be connected to one another in elongated form or at right angles.

In the three-sided embodiment of the connecting part 35, according to FIG. 7 two flexible lines 39, 40 and a rigid line 41 are connected to one another. The rigid line may once again be a metal tube, a continuous flow heater, for example.

The rigid line is provided with a soldered-on coupling sleeve 42 at its connection point to the connecting part 35, and comprises a first section 43 which receives an end section of the line 41, and a second, end-side section 44 of smaller diameter which can be inserted into a central line section of the connecting part 35. Between the first section 43 and the second section 44 of the coupling sleeve 42 a shoulder is formed which supports a sealing O-ring 45. On its other side, the O-ring 45 rests on a shoulder of the connecting sleeve 36 or a connecting sleeve section of the connecting part 35, at which point the connecting sleeve section merges into the line section 46 of the connecting part 35, which has a smaller diameter than the outwardly oriented connecting sleeve section. For locking the rigid line 41 inserted into the connecting part 35 to the connecting part, and therefore also to the other lines opening into the connecting part, a spring clamp 47 is used which on one side rests in a receiving slot, not designated by a reference number, in the connecting sleeve 36 and on the other side pushes against a rear, in FIG. 7 an upper, end face of the coupling sleeve 42.

The connecting sleeves 37, 38 or connecting sleeve sections are shaped in the same way as the connecting sleeve 36 for the connecting part 35, and are used for connecting the two flexible lines 39, 40 to the connecting part 35, for which purpose end sections of the lines 39, 40 are provided with coupling sleeves and support tubes, not designated by reference numbers, as in the embodiments according to FIGS. 1 through 5. Tightly fitting O-rings 48, 49 are enclosed between the end-side, i.e., connection-side, end faces of the coupling sleeves and the shoulders of the connecting sleeves 37, 38. In this instance as well, the end sections of the lines 39, 40 are held in their inserted position by spring clamps 50, 51.

The system of the connecting device for fluid conduits thus comprises only a few components, which may be combined with one another in numerous ways, namely: coupling sleeves, optionally with support tubes, connecting sleeves, or O-rings for sealing, and spring clamps or interlockable half-shells for locking the connection.

1. A connecting device for fluid conduits having at least one connecting element that is suitable for tightly connecting two line ends to one another, wherein
a coupling sleeve (4) having a front annular end face and a rear annular end face makes positive friction fit contact with an end section of a first line (1),
a connecting sleeve (5, 14) projects from one end of a second line (2, 13), and inside the connecting sleeve an annular shoulder is formed that is suitable for receiving the end section of the first line (1) together with the coupling sleeve (4), and
a locking element can be detachably mounted on the connecting sleeve (5, 14) which contacts the rear end face of the coupling sleeve (4) inserted into the connecting sleeve, characterized in that
the inside of the coupling sleeve (4) has a continuous cylindrical peripheral wall and is placed on a continuous cylindrical end section of the first line (1), and
the front annular end face of the coupling sleeve (4) indirectly or directly makes a sealing contact on the annular shoulder of the connecting sleeve (5, 14).

2. The connecting device for fluid conduits according to claim 1, characterized in that an O-ring (7) is enclosed between the annular shoulder of the connecting sleeve (5, 14) and the front annular end face of the coupling sleeve (4) in such a way that the O-ring (7) on one side contacts the front annular end face of the coupling sleeve (4) and on the other side contacts the annular shoulder of the connecting sleeve (5, 14).

3. The connecting device for fluid conduits according to at least one of claims 1 and 2, characterized in that the exterior of the coupling sleeve (4) and the interior of the connecting sleeve (5, 14) are essentially cylindrical.

4. The connecting device for fluid conduits according to at least one of claims 1 through 3, characterized in that the connecting sleeve (5) is an injection-molded plastic part.

5. The connecting device for fluid conduits according to claim 4, characterized in that the connecting sleeve (5) together with the end of the second line (2) are formed from plastic.

6. The connecting device for fluid conduits according to at least one of claims 1 through 3, characterized in that a metal connecting sleeve (14) that is soldered onto an end section of a metal tube as a second line (13).

7. The connecting device for fluid conduits according to at least one of claims 1 through 6, characterized in that the coupling sleeve (4) is designed as a ring which is tightly mounted on the end section of the first line (1), at a distance from one end thereof.

8. The connecting device for fluid conduits according to at least one of claims 1 through 6, characterized in that an additional coupling sleeve (42) has a first section (43) which receives an end section of the first line (41), and also has a second section (44) that is narrower than the first section and that projects from one end of the first line (41), the front annular end face of the coupling sleeve being formed by a shoulder between the first section (43) and the second section (44).

9. The connecting device for fluid conduits according to at least one of the preceding claims, characterized in that a support tube (6) is inserted in the end section of the first line (1) in such a way that the end section is enclosed between the support tube (6) and at least one section of the coupling sleeve (4).

10. The connecting device for fluid conduits according to at least one of claims 1 through 4 and claims 6 through 9, characterized in that at least two connecting sleeves (36, 37, 38) are formed in a common connecting part (35) which comprises at least one line section (46) that connects the connecting sleeves.

11. The connecting device for fluid conduits according to at least one of claims 1 through 4 and claims 6 through 9, characterized in that the connecting sleeve (5) is an integral component of a structural element (3).

12. The connecting device for fluid conduits according to at least one of claims 1 through 11, characterized in that the locking element is designed as a spring clamp (8, 9, 47, 50, 51) that extends through an internally laterally open receiving slot (10, 11a, 11b) in the connecting sleeve (5, 12) and comes to rest against the rear annular end face of the inserted coupling sleeve (4, 42).

13. The connecting device for fluid conduits according to claim 12, characterized in that the receiving slot (11a, 11b) in the connecting sleeve (12) is also laterally open to the outside.

14. The connecting device for fluid conduits according to claim 12, characterized in that the receiving slot (10) in the connecting sleeve (5) is laterally closed to the outside.

15. The connecting device for fluid conduits according to at least one of claims 1 through 11, characterized in that
the locking element is designed as mutually connectable half-shells (18, 19, 30, 31) having interlocking elements, and
on their end faces the half-shells have ridges (26, 27, 28, 29) with recesses, so that the coupling sleeve (4) and the connecting sleeve (14) which receives the coupling sleeve are enclosed between the folded-together, mutually connected half-shells (18, 19) and the ridges (26-29).

16. The connecting device for fluid conduits according to claim 15, characterized in that the two half-shells (30, 31) are made of plastic and are connected as a single piece by means of a film hinge (32).
